(19) United States
(12) Patent Application Publication
(10) Pub. No.: US 2021/0100370 A1
(43) Pub. Date: Apr. 8, 2021

(54) INFANT SLEEPER

(71) Applicant: DreamNest, LLC, Ann Arbor, MI (US)

(72) Inventors: Lindsay Charlie Brink, Edgerton, MN (US); Allen Samuels, Ann Arbor, MI (US)

(21) Appl. No.: 16/606,880

(22) PCT Filed: Apr. 23, 2018
(86) PCT No.: PCT/US18/28857

§ 371 Date: Oct. 21, 2019

Related U.S. Application Data
(60) Provisional application No. 62/488,195, filed on Apr. 21, 2017.

(51) Int. Cl. A47D 15/00; A47D 7/00; A47D 7/04; B31D 1/00; B31D 5/00

(52) U.S. Cl. CPC A47D 15/008; A47D 7/002; B31D 5/00; B31D 1/0075; A47D 7/04

(57) ABSTRACT

A barrier for an infant that has a central portion sized to receive an infant thereon and a first and second side portion extending partially away from the central portion. Wherein the central portion and first and second side portions are formed from folds in an integral material.

### CROSS-REFERENCE TO RELATED APPLICATIONS

This application is a national phase entry of International Application No. PCT/US18/28857 which claims the benefit of U.S. Provisional Application No. 62/488,195 titled “INFANT SLEEPER” and filed Apr. 21, 2017, the contents of which are incorporated herein in their entirety.

### TECHNICAL FIELD

The present teachings are related to an infant sleeper and more specifically to an infant sleeper that is substantially formed from a series of folds and bends in a material.

### BACKGROUND

Allowing an infant to sleep in the same bed as an adult creates certain risks for the child such as being crushed or otherwise unintentionally suffocated by the adult. Cribs or bassinettes can be costly and difficult to assemble. Often people share a bed with an infant to avoid purchasing an expensive crib or bassinette. Alternatively, some parents want to have their infant within reach as a way to easily reach the infant for breast feeding at night or to simply have the infant close by. Moreover, in some countries, parents often place infants on the ground to sleep, making them susceptible to unwanted interactions with animals and/or injurious unintentional human contact. The cost of traditional infant sleepers such as cribs and bassinettes are cost prohibitive in the United States and abroad to many parents, as well as social service and aid organizations which may desire to provide help to parents with infants. Moreover, it may be impractical, infeasible, or impossible to ship traditional infant sleepers to developing countries due to various factors, including social unrest and high shipping costs. Further still, many locations may not have access to the tools required for assembly of many conventional infant sleepers.

Because of the foregoing, there is a need to develop and utilize an infant sleeper that is inexpensive to manufacture and ship, simple to assemble and that addresses the realities of local and global socioeconomic factors that contribute to infant mortality. The present application is intended to improve upon and resolve some of these known problems within the art.

### SUMMARY

One embodiment is a barrier for an infant that has a central portion sized to receive an infant thereon and a first and second side portion extending partially away from the central portion. Wherein the central portion and first and second side portions are formed from folds in an integral material.

In one example of this embodiment, the first and second side portions are the only portions that extend partially away from the central portions.

In another example of this embodiment, the first and second side portions have a triangular cross section.

In yet another example of this embodiment, the integral material is paperboard.

In another example of this embodiment, the folds of the integral material result in a first edge and a second edge of the integral material being aligned substantially adjacent one another at a seam. In one aspect of this example, the seam is located along a middle section of the central portion.

Yet another example of this embodiment has a first hand hole defined in the first side portion and a second hand hole defined in the second side portion.

Another example has a first D-shaped section coupled to the first side portion and a second D-shaped section coupled to the second side portion, wherein the first and second D-shaped sections are sized to allow netting to be positioned over the central portion without contacting an infant positioned therein.

Yet another example of this embodiment has a first side support extending between the first and second side portions at a first end and a second side support extending between the first and second side portions at a second end. Wherein, the first and second side supports are sized to raise the central portion off an underlying surface. One aspect of this example includes a first support through hole defined by the first side support and a second support through hole defined by the second side support, wherein the first and second side supports are sized to receive a central support therethrough. In another aspect of this example, the first and second support through holes have a triangular shaped periphery and the central support is sized to be positioned within the first and second support in a V-shaped orientation.

Another embodiment of the present disclosure is a bed assembly configured to be placed on an underlying surface that has a bed portion, a first side support section coupled to the bed portion, and a second side support section coupled to the bed portion at an opposite end relative to the first side support section. Wherein, the first side support section, the second side support section, and the bed portion are formed from folds in a material.

In one example of this embodiment, the bed portion is elevated relative to the underlying surface by the first and second side support sections.

In another example of this embodiment, the first side support section defines a first through hole therein and the second side support section defines a second through hole therein. Wherein the first and second through holes are sized to receive a central support therethrough. In one aspect of this example, the first and second through holes are positioned to align the central support with a bottom seam of the bed portion. In another aspect of this example, the central portion defines cutouts therein, wherein when the central support is positioned within the corresponding first and second through holes a portion of the first and second side support sections is positioned in corresponding cutouts of the central support.

Yet another example of this embodiment has a first D-shaped section coupled to the first side portion and a second D-shaped section coupled to the second side portion, wherein the first and second D-shaped sections are sized to allow netting to be positioned over the central portion without contacting an infant positioned therein.

Another embodiment of the present disclosure includes a method for instructing a user to build a barrier for an infant, the method being providing a substantially flat material with a plurality of fold indications positioned thereon, instructing the user to execute folds along the plurality of fold indications to manipulate the material to define a central portion sized to receive an infant thereon and a first and second side portion extending partially away from the central portion, and instructing the user to apply a mechanical or adhesive fastener to the material to maintain the instructed configuration of the central portion and the first and second side portions.

One example of this embodiment includes instructing a user to fold down a first side support and a second side support to elevate the central portion off an underlying surface. One aspect of this example involves instructing the user to position a central support between the first side support and the second side support.

### DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1A is a perspective view of a barrier tray embodiment of the present disclosure;

FIG. 1B is an a top view of the barrier tray of FIG. 1A in an unfolded flat configuration;

FIG. 1C is a side view of a partially folded barrier tray of FIG. 1A;

FIG. 2A is a perspective view of an elevated infant bed;

FIG. 2B is a perspective view of a folded flat configuration of the elevated infant bed of FIG. 2A;

FIG. 2C is a perspective view of a partially assembled elevated infant bed of FIG. 2A;

FIG. 2D is a perspective view of the elevated infant bed of FIG. 2A illustrating folds of a bottom section;

FIG. 2E is a perspective view of the elevated infant bed of FIG. 2A illustrating folds along side sections;

FIG. 2F is a perspective view of the elevated infant bed of FIG. 2A illustrating folds along a top section;

FIG. 3A is a top view of a central portion;

FIG. 3B is a perspective view of the central portion from FIG. 3A in a partially folded configuration;

FIG. 3C is a side view of one embodiment of a through hole for that corresponds with the central portion of FIG. 3A;

FIG. 4A is a perspective view of another embodiment of the present disclosure;

FIG. 4B is a perspective view of another embodiment of the present disclosure;

FIG. 4C is a perspective view of another embodiment of the present disclosure;

FIG. 4D is a perspective view of another embodiment of the present disclosure;

FIG. 4E is a perspective view of another embodiment of the present disclosure;

FIG. 5A is a perspective view of another embodiment of the present disclosure illustrated coupled to a bed;

FIG. 5B is a perspective view of the embodiment of FIG. 5A isolated from the bed;

FIG. 5C is a top view of the embodiment of FIG. 5B;

FIG. 5D is a perspective view of another embodiment of the present disclosure;

FIG. 6A is a perspective view of another embodiment of the present disclosure;

FIG. 6B is a top view of an unfolded flat infant sleeper with integrated netting spacers;

FIG. 7A is a perspective view of the elevated infant bed from FIG. 2A coupled to a cradle base;

FIG. 7B is an isolated perspective view of the cradle base from FIG. 7A;

FIG. 7C is a top view of the cradle base of FIG. 7B in a flat orientation;

FIG. 7D is a perspective view of the cradle base from 7B in a partially folded configuration;

FIG. 8A is a perspective view of the elevated infant bed from FIG. 2A with a drawer assembly positioned thereunder;

FIG. 8B is an isolated perspective view of the drawer assembly of FIG. 8A; and

FIG. 8C is a perspective view of the drawer assembly of FIG. 8B in a partially folded configuration.

Corresponding reference numerals are used to indicate corresponding parts throughout the several views.

### DETAILED DESCRIPTION

The above-mentioned aspects of the present application and the manner of obtaining them will become more apparent and the teachings of the present application itself will be better understood by reference to the following description of the embodiments of the present application taken in conjunction with the accompanying drawings.

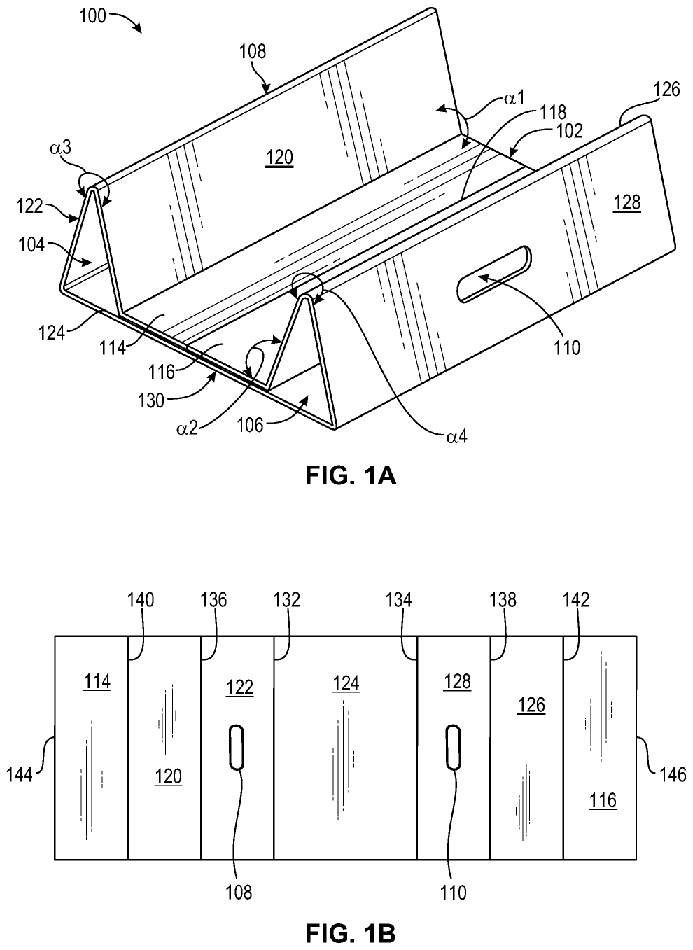

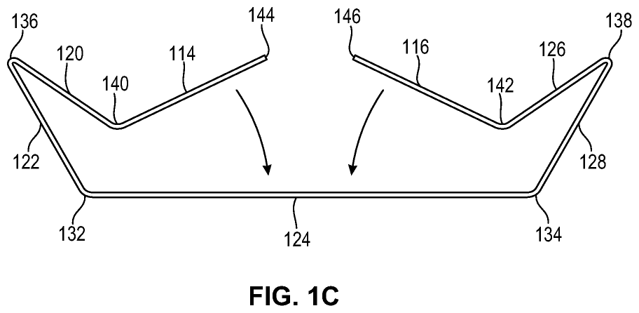

Referring now to FIGS. 1A-1C, an infant sleeper barrier 100 is illustrated. The sleeper barrier 100 may have a central portion 102 defined between a first and second side portion 104, 106. In one non-exclusive example, the sleeper barrier 100 may be an about twenty-six inch long by eighteen inch wide base with five inch high side portions 104, 106. The sleeper barrier 100 may be made of corrugated paperboard, cardboard, plastic, foam, paper, or any other material having the proper structural features to implement the teachings of this disclosure. In one aspect of this disclosure, the form of the sleeper barrier 100 is created through a series of folds in a single material as is described herein. Further, any combination of glue, tape, staples, or the like may be used to maintain the form of the sleeper barrier 100. However, in other embodiments no adhesive or couplers are used at all. In this embodiment, slots and locking tabs are positioned as necessary to maintain the corresponding material in the proper orientation.

In one aspect of this disclosure, the sleeper barrier 100 is sized to be placed in a bed where an adult will sleep with an infant. The infant is placed on its back, onto a foam mattress which may be included with the sleeper barrier 100 and is sized to fit at least partially in the central portion 102. The sides 104, 106 of the sleeper barrier 100 may function as barriers that restrict an individual or object from accidentally becoming positioned within the central portion 102 near the infant. The sides 104, 106 are sized and shaped to make it very uncomfortable and difficult for others laying in the bed to inadvertently roll over the sides 104, 106 and become positioned within the central portion 102, thus protecting the infant.

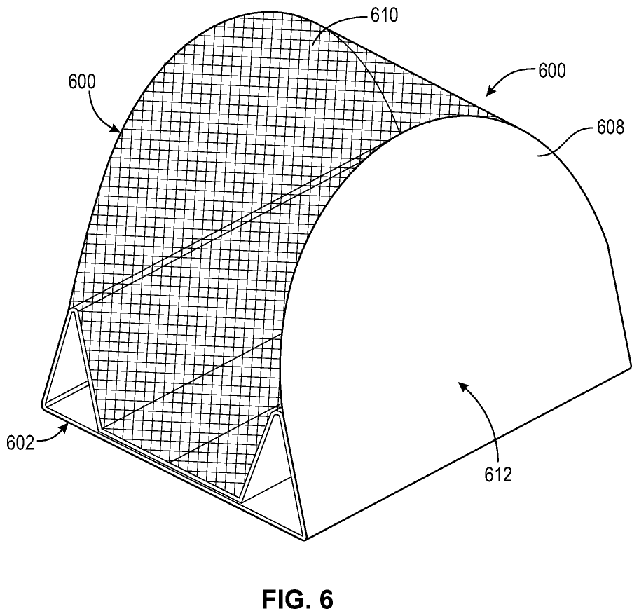

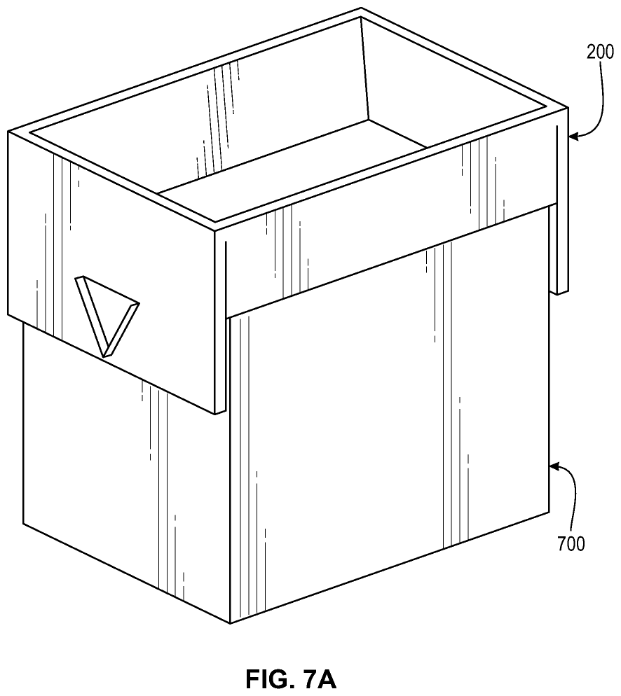

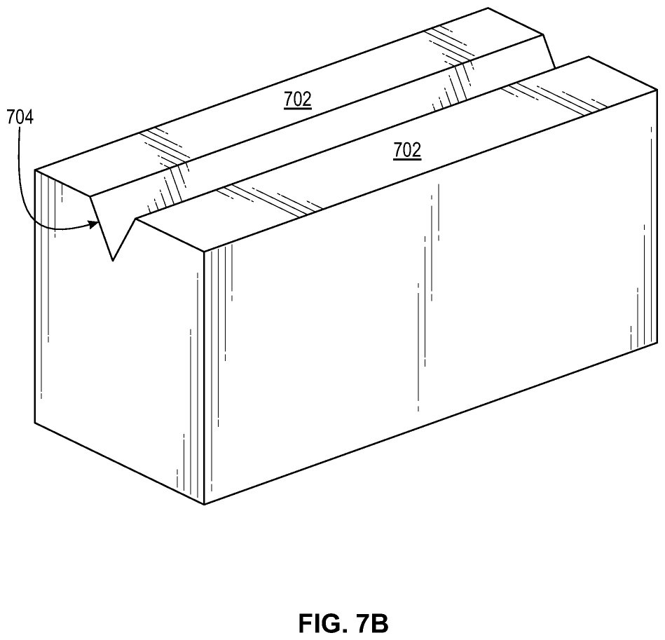

As will be described in more detail below with reference to FIG. 6, one embodiment of this disclosure includes two “D” shaped paperboard panels can support netting that would be draped over the entire unit resulting in a space that can be substantially void of insects or other unwanted debris and still allow ample airflow.

In one non-exclusive example of this disclosure, any of the embodiments described herein may be formed from one piece of two ply corrugated paperboard that is die cut, scored, folded, and fastened as will be described in more detail herein. The paperboard may be white or Kraft paper. The sleeper barrier 100 may include a first and second hand hole 108, 110, one defined in part through each corresponding side 104, 106. In another embodiment of this disclosure, the sleeper barrier 100 may be made of a skinned and soft, yielding, rigid foam. This embodiment would be solid foam and provide a very comfortable and high friction bottom surface where the sleeper barrier 100 makes contact with a top sheet and mattress. In one none-exclusive example, a non-off gassing, nonflammable foam may be used.

In one embodiment, the sleeper barrier 100 may be made from a series of folds or bends in a substantially integral material such as paperboard. In this embodiment, the central portion 102 may be formed from a first and second central panel 114, 116 that are positioned substantially adjacent one another along a seam 118. In the embodiment illustrated in FIG. 1, the seam 118 may be at a substantially midpoint between the respective sides 104, 106; however, this disclosure also considers positioning the seam 118 anywhere along the central portion 102 and is not limited to the particular location shown.

The first side 104 is formed from a first interior side 120 and a first exterior side 122. The first interior side 120 may be formed from a bend in the first central panel 114 away from a plane defined by the central portion 102. The bend may be any appropriate angle α1 relative to first central panel 114 that is adequate to allow the first interior side 120 to extend away from the central portion 102 a sufficient distance to substantially protect an infant positioned therein. In one non-exclusive example the angle α1 between the surfaces of the first central panel 114 and the first interior side 120 may be greater than ninety degrees. However, in other embodiments the angle α1 between the first central panel 114 and the first interior side 120 may be ninety degrees or less and this disclosure considers many different angular orientations there between.

The first exterior side 122 may be formed from a bend relative to the first interior side 120. In one non-exclusive example, the first exterior side 122 may be a bend angle α3 of between about two-hundred and seventy degrees and three-hundred and sixty degrees with determined from the exterior planes defined by the first interior side 120 and the first exterior side. The first exterior side 122 may extend from the first interior side 120 to a base portion 124 to form a substantially triangular cross-section along the first side portion 104.

Similarly, the second side 106 is formed from a second interior side 126 and a second exterior side 128. The second interior side 126 may be formed from a bend in the second central panel 116 away from a plane defined by the central portion 102. The bend may be any appropriate angle α2 relative to second central panel 116 that is adequate to allow the second interior side 126 to extend away from the central portion 102 a sufficient distance to substantially protect an infant positioned therein. In one non-exclusive example the angle α2 between the surfaces of the second central panel 116 and the second interior side 126 may be greater than ninety degrees. However, in other embodiments the angle α2 between the second central panel 116 and the second interior side 126 may be ninety degrees or less and this disclosure considers many different angular orientations therebetween.

The second exterior side 128 may be formed from a bend in the second interior side 126. In one non-exclusive example, the second exterior side 128 may be a bend angle a4 of between about two-hundred and seventy degrees and three-hundred and sixty degrees relative to the surface of the second interior side 126. The second exterior side 128 may extend from the second interior side 126 to the base portion 124 to form a substantially triangular cross-section along the second side portion 106.

The triangular side sections 104, 106 may be sized to provide several features of the sleeper barrier 100. For example, the interior and exterior sides 120, 126, 122, 128 may have a sufficient length to extend far enough away from the central portion 102 to substantially restrict an infant from rolling out of the central portion 102. In one aspect of this disclosure, the sides 104, 106 are sized to prevent an infant from rolling out of the central portion even when a padded mattress or the like is placed therein.

In another aspect of this disclosure, the portion of the sides 104, 106 defined by the base portion 124 is sufficiently wide to provide stability to the sides 104, 106 during contact. For example, the base of the sides 104, 106 is wide enough that it is difficult for the infant to bend the corresponding side 104, 106 away from the central portion 102, thereby restricting the infant from unintentionally rolling over the side portion 104, 106. Further still, the portion of the sides 104, 106 defined by the base portion 124 is wide enough to make it difficult for an adult to deform as well. In this configuration, it may be difficult for anyone sleeping in the bed to unintentionally become positioned in the central portion 102 without contacting the corresponding side portion 104, 106, thus preventing unintentional interaction between the infant and adult.

In one aspect of this disclosure, the base portion 124 may extend between the first and second side portion 104, 106 and provide a bottom surface 130. The bottom surface 130 may be the portion of the sleeper barrier 100 that contacts the bed or other surface that the sleeper barrier 100 is placed upon. Accordingly, in one embodiment of this disclosure the bottom surface 130 may have a surface with frictional properties that discourage sliding. For example, the bottom surface 130 may have a rubber or the like coating thereon. However, this disclosure is not limited to any particular material along the bottom surface 130, and contemplates any material that may restrict the infant sleeper 100 from sliding once the sleeper barrier 100 is set on a surface. Further, some embodiments of this disclosure do not have any additional material added to the bottom surface 130 but rather rely on the surface of the paperboard or the like to substantially restrict sliding of the sleeper barrier 100.

Referring now to FIG. 1B, the sleeper barrier 100 is shown in an unfolded and substantially flat orientation. In the unfolded orientation of FIG. 1B, the infant sleeper 100 may be easily transportable. Further, the sleeper barrier 100 can be transitioned from the unfolded orientation of FIG. 1B to the assembled orientation of FIG. 1A through a series of folds as described herein. More specifically, the sleeper barrier 100 may have a first and second base fold 132, 134 positioned on opposing sides of the base portion 124. In one aspect of this embodiment, the first and second base folds 132, 134 may be spaced from one another to establish the overall width of the sleeper barrier 100.

A first and second ridge fold 136, 138 are defined between the corresponding first interior and exterior sides 120, 122 and the second interior and exterior sides 126, 128. The ridge folds 136, 138 define the outermost portion of the first and second side portions 104, 106 relative to the base portion 124 when the sleeper barrier 100 is fully assembled as in FIG. 1A.

Similarly, first and second central folds 140, 142 are defined between the corresponding first internal side 120 and first central panel 114 and the second internal side 126 and second central panel 116. Further, the first central panel 114 may terminate at a first edge 144 and the second central panel 116 may terminate at a second edge 146. In this configuration, the location of the folds 132, 134, 136, 138, 140, 142 may define the size and shape of the central portion 102 and the side portions 104, 106 as described herein. More specifically, the size of the sides and panels may be such that once the infant sleeper is in the assembled orientation of FIG. 1A the first edge 144 and the second edge 146 are substantially adjacent to one another along the seam 118 of the central portion 102.

The location of the folds 132, 134, 136, 138, 140, 142 may be defined in the paperboard or like material in any number of ways. More specifically, the location of the folds may be identified through markings on the surface of the paperboard, thereby illustrating to a user where to fold the paperboard to create the assembled sleeper barrier 100 of FIG. 1A. In another embodiment some or all of the folds 132, 134, 136, 138, 140, 142 may be identified by perforations in the paperboard thereby making it easy for the user to bend the paperboard along the corresponding fold. In yet another embodiment, the folds 132, 134, 136, 138, 140, 142 may be preset into the paperboard in a pre-folding process. In this configuration, the paperboard may be folded into the assembled configuration of FIG. 1A to establish the proper fold lines as part of a manufacturing step. Then, the sleeper barrier 100 may be unfolded to the substantially flat orientation of FIG. 1B prior to being shipped or otherwise sent to a user. Once the user receives the flat sleeper barrier 100, the user may refold the sleeper barrier 100 into the assembled orientation by utilizing the pre-folded lines. Accordingly, this disclosure considers many different methods for establishing the folds 132, 134, 136, 138, 140, 142, including those known in the art but not specifically described.

Referring now to FIG. 1C, a partially folded sleeper barrier 100 is shown. In one aspect of this disclosure, a user can create the assembled sleeper barrier 100 of FIG. 1A from the flat orientation of FIG. 1B by executing several folds along the fold lines 132, 134, 136, 138, 140, 142. More specifically, the user may start by folding first and second base folds 132, 134 so that the first and second exterior sides 122, 128 are angled away from the base portion 124 in the same direction. Next, the first and second ridge folds 136, 138 may be utilized to position the first and second interior sides 120, 126 so they partially face one another. The first and second central folds 140, 142 may then be implemented as the first and second central panels 114, 116 are aligned adjacent to the base portion 124. Next, the first and second edge 144, 146 may be aligned to substantially contact one another along the seam 118.

In one example of this embodiment, the first and second central panels 114, 116 may be glued to the adjacent base portion 124 once positioned in the assembled configuration of FIG. 1A. Alternatively, staples, tape, Velcro, slots and locking tabs, or any other type of fastener or adhesive may be used to maintain the sleeper barrier 100 in the assembled position of FIG. 1A. Further still, in one non-exclusive example, the seam 118 is positioned at a substantially midpoint along the central portion 102. Positioning the seam 118 at this location allows the weight of the infant to press the central panels 114, 116 towards the base portion 124 and thereby maintain the form of the sleeper barrier 100 when the infant is positioned therein. Accordingly, this disclosure considers many different techniques for maintaining the form of the sleeper barrier 100.

In one aspect of this disclosure, the sleeper barrier 100 can be shipped by partially folding the sleeper barrier 100. More specifically, any one of the folds 132, 134, 136, 138, 140, 142 may be utilized to execute a substantially one-hundred and eighty degree fold in the sleeper barrier 100 to reduce the overall length for shipping. In one non-exclusive example, a substantially one-hundred and eighty degree fold at the first base fold 132 may be executed prior to shipping the sleeper barrier 100 to minimize the overall length of the material during shipment. Further still, an entirely new fold along a center point of the sleeper barrier 100 may be executed so that the paperboard may be folded in half prior to shipment. Accordingly, any number of folding techniques and locations is considered herein to reduce shipping size.

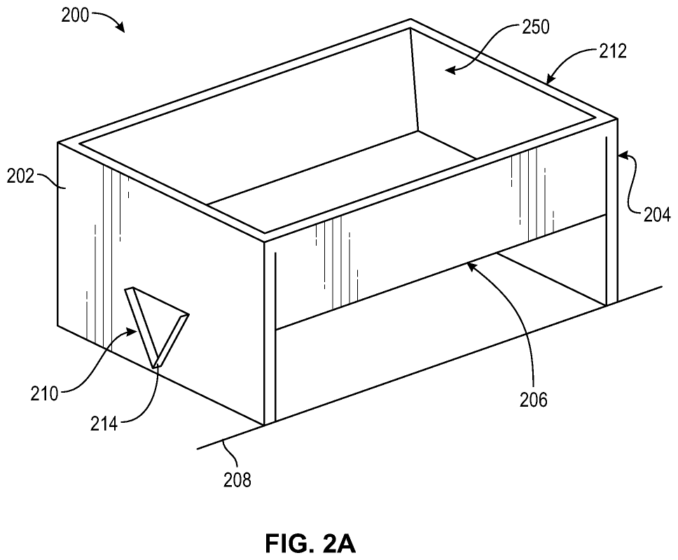

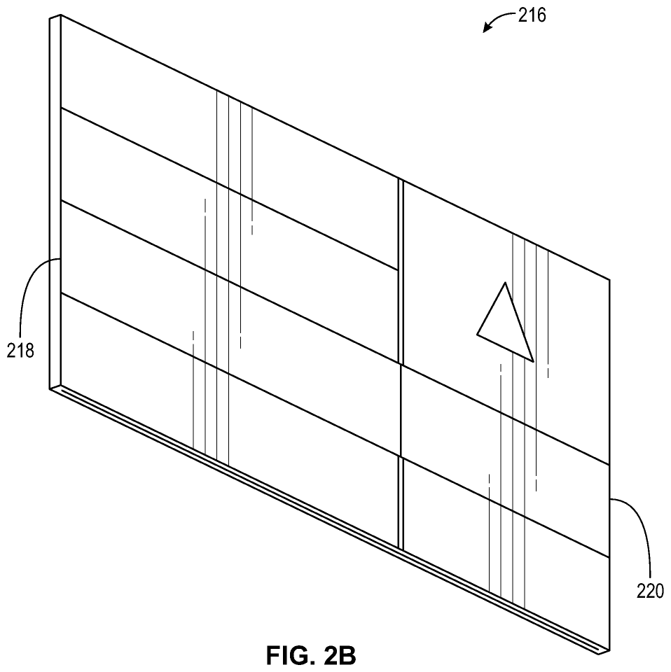

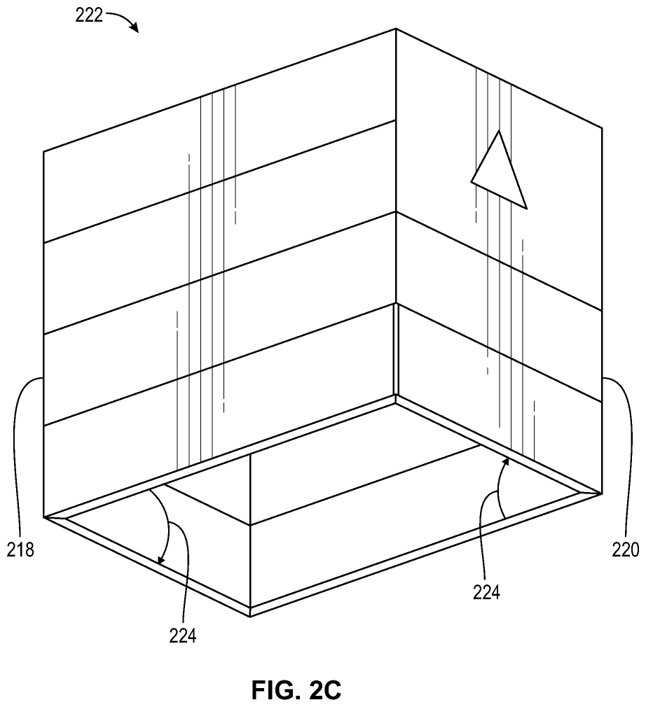

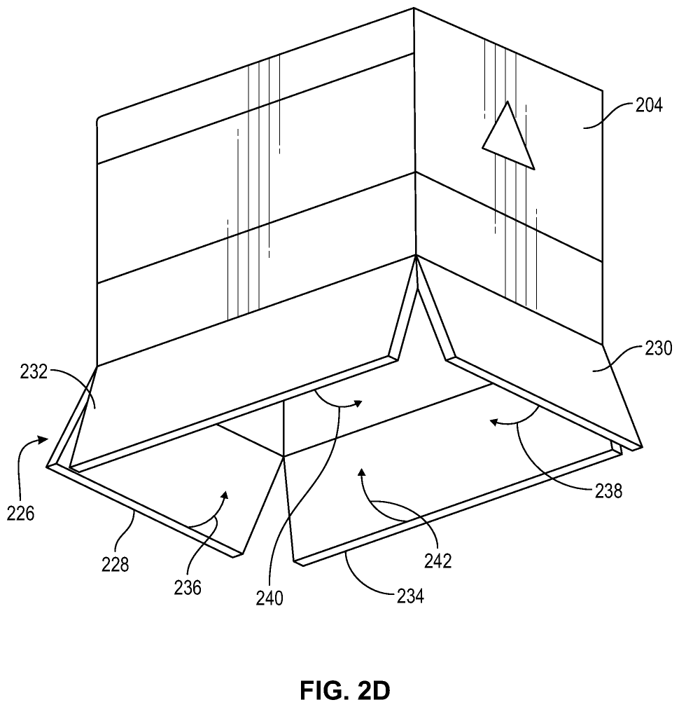

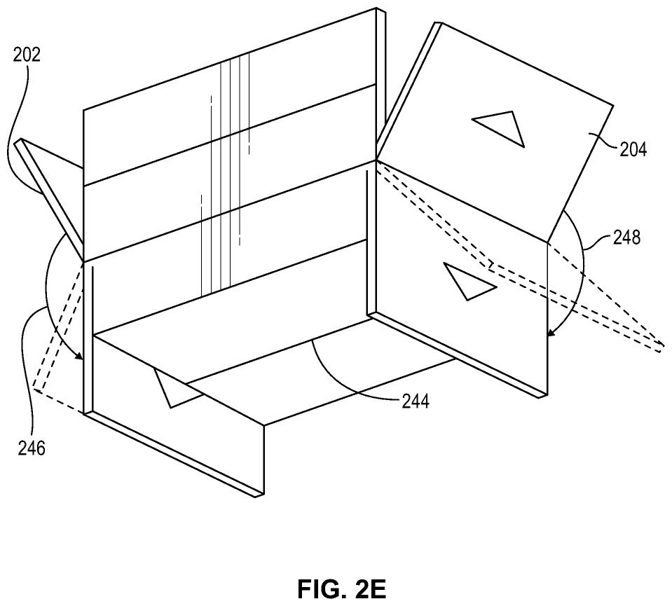

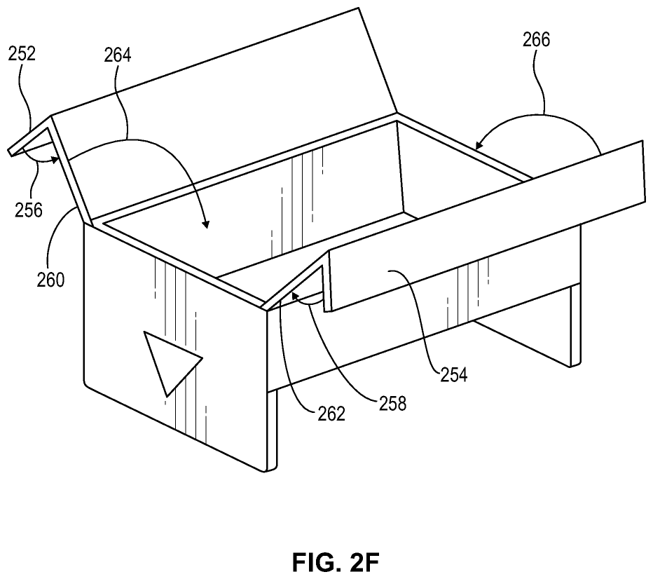

Referring now to FIG. 2A, one embodiment of an assembled elevated infant bed 200 is illustrated. The assembled bed 200 has first and second side supports 202, 204 that raise a bed portion 206 above an underlying surface 208. A first and second support through hole 210, 212 are defined through the corresponding first and second side supports 202, 204. Further, a central support 214 may be positioned through the first and second support through holes 210, 212 to thereby provide additional structural support to the bed portion 206.

In one aspect of this embodiment, the entire bed 200 is formed from substantially one integral material with the exception of the central support 214. In this embodiment, the first and second side supports 202, 204 and the bed portion 206 may be formed from a single piece of paperboard or the like material that has cuts and folds positioned to allow the paperboard to be formed as shown. The central support 214 may similarly be formed of paperboard or the like but be separable from the paperboard that defines the side supports 202, 204 and the bed portion 206.

Similarly to the sleeper barrier 100, the bed 200 may be formed by executing a series of folds in a paperboard template. More specifically, a paperboard material may have cutouts and fold indications that allow the paperboard material to transition from a substantially planar component to the assembled bed 200 shown and described herein. In one non-limiting example, this may be achieved by executing a series of folds as shown and described herein.

Referring now to FIGS. 2B-2F, one embodiment of an assembly method for the bed 200 is illustrated and described. More specifically, in FIG. 2B the bed 200 is shown in a substantially flat configuration 216. In the flat configuration 216, the bed 200 may have only a first and second fold 218, 220 executed along a first and second end thereof. The first and second folds 218, 220 may be defined, in part, along opposite corners of the bed portion 206 to allow the bed 200 to be reduced to two substantially equally sized layers of paperboard aligned adjacent to one another. The flat configuration 216 may be a transport configuration that allows the bed 200 to easily be shipped or otherwise transported to other locations. In other words, the flat configuration 216 may be configured to orient the bed 200 in a size and shape this is preferred for shipping and transport.

Referring now to FIG. 2C, an opened configuration 222 is illustrated. In the opened configuration 222, paperboard is manipulated about the first and second folds 218, 220 in an open direction 224 until the paperboard forms four walls in a substantially rectangular cross-section. In this embodiment, the paperboard is manipulated about the folds 218, 220 until the adjacent paperboard panels are substantially ninety degrees offset from one another.

Referring now to FIG. 2D, a bed bottom portion 226 is illustrated. The bed bottom portion 226 has a first, second, third, and fourth side 228, 230, 232, 234 that each fold along the paperboard at a location adjacent to a bottom part of the bed portion 206. More specifically, after the user positions the paperboard in the open configuration 222, the user may fold the first and second sides 228, 230 towards one another in a corresponding first and second fold direction 236, 238. The first and second sides 228, 230 may be rotated in the first and second fold directions 236, 238 until the first and second sides 228, 230 are substantially coplanar. In other words, the first and second sides 228, 230 may be folded relative to the adjacent wall portion until they are substantially ninety degrees relative thereto.

After the first and second sides 228, 230 are folded as described above, the third and fourth sides 232, 234 may be similarly folded by the user. The third and fourth sides 232, 234 may be folded to become positioned partially adjacent to the first and second sides 228, 230 to form the bed bottom portion 226 as shown in the assembled configuration of FIG. 2A. More specifically, the user may fold the third and fourth sides 232, 234 towards one another in a corresponding third and fourth fold direction 240, 242. The third and fourth sides 232, 234 may be rotated in the third and fourth fold directions 240, 242 until the third and fourth sides 232, 234 are substantially coplanar and located at least partially adjacent to the first and second sides 228, 230. In other words, the third and fourth sides 232, 234 may be folded relative to the adjacent wall portion until they are substantially ninety degrees offset therefrom.

In one aspect of this disclosure, the third and fourth sides 232, 234 fold together to become substantially adjacent one another. In other words, the distal edge of each side 232, 234 may be positioned adjacent one another along a bottom seam 244 (see FIG. 2E). In this configuration, adhesive or any other coupling method may be used to couple the third and fourth sides 232, 234 to one another. In one non-exclusive example, tape may be positioned along the bottom seam 244 to maintain the position of the third and fourth sides 232, 234. Alternatively, in another non-exclusive example a surface of the third and fourth sides 232, 234 may be glued to a surface of the corresponding first and second sides 228, 230 once they are positioned adjacent one another as described herein. Further still, in another example staples are utilized along the bottom seam 244 to maintain the bottom portion 226 in a closed orientation. Accordingly, this disclosure considers any type of coupling or fastening method or device along the bottom seam 244 to maintain the position of the sides 228, 230, 232, 234.

Alternatively, or in addition to any of the coupling methods described above, the central support 214 may be positioned substantially adjacent to the bottom seam 244 once installed through the support through holes 210, 212 as described herein. In this configuration, the central support 214 may substantially restrict the third and fourth sides 232, 234 from unfolding once positioned as described above. In one embodiment, the central support 214 may be the only means required to maintain the bottom portion 226 in the folded position. However, other embodiments utilize the fastening and coupling techniques described above along with the central support 214 to maintain the folded position.

Once each of the sides 228, 230, 232, 234 have been folded as described above, the first and second side supports 202, 204 may be folded down as illustrated in FIG. 2E. More specifically, the first side support 202 may be folded substantially one-hundred and eighty degrees in the fifth fold direction 246. Similarly, the second side support 204 may be folded substantially one-hundred and eighty degrees in the sixth fold direction 248. Each of the first and second side supports 202, 204 may be maintained in the folded orientation utilizing staples, tape, glue, slots and locking tabs, or any other fastening method or device known in the art and this disclosure considers many different ways to maintain the orientation of the side supports 202, 204. Further, in one non-limiting example the central support 214 may extend through the first and second support through holes 210, 212 to maintain the folded orientation of the first and second side supports 202, 204.

Once the side supports 202, 204 are in the folded orientation described above, a central portion 250 (see FIG. 2A) is formed by making the folds shown in FIG. 2F. The central portion 250 can be formed by partially folding a first and second central panel 252, 254 in corresponding first and second central portion fold directions 256, 258. Next, first and second interior sides 260, 262 may be folded in corresponding first and second interior directions 264, 266 to become positioned within the central portion 250.

In one aspect of this example, the first and second central portions 252, 254 may substantially align with one another along a central seam in the central portion 250 similarly to the sleeper barrier 100 described above. Further, the first and second side 260, 262 may be at least slightly angled inwardly when the first and second central portions 252, 254 are properly aligned. The angled sides 260, 262 may strengthen the corresponding side sections by defining a triangular cross section similarly to that described above for the sleeper barrier 100.

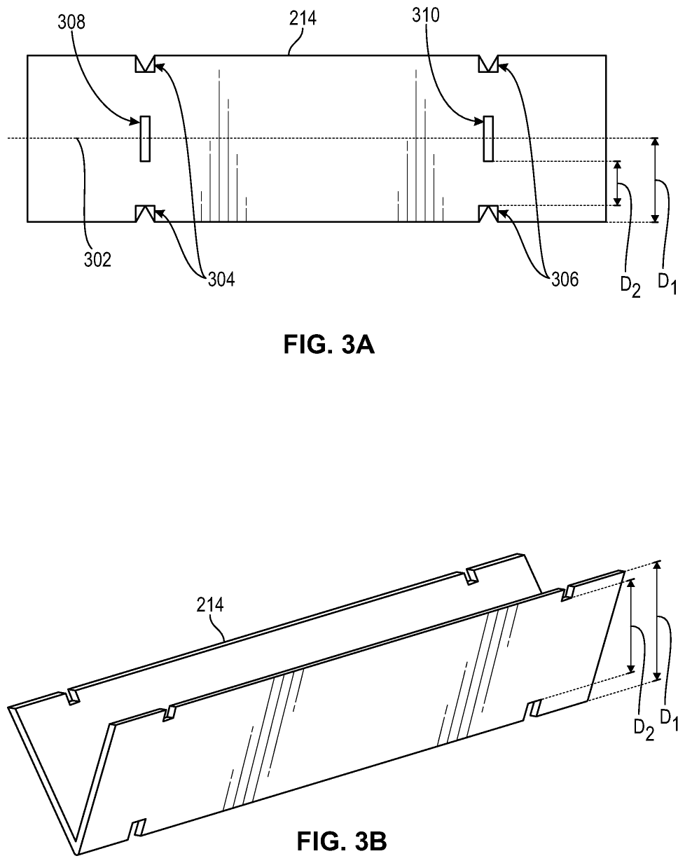

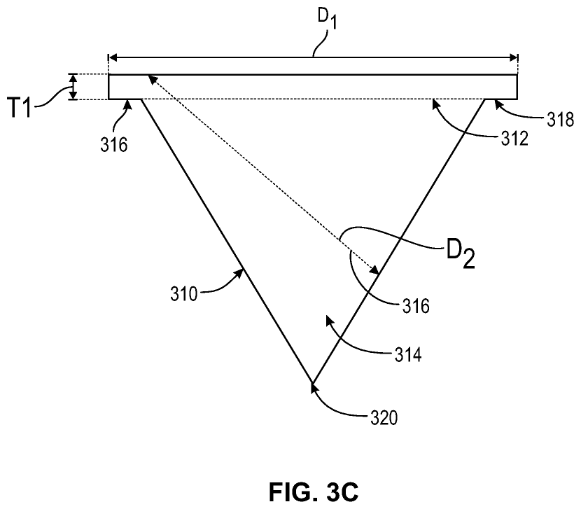

Once all of the folds for the infant bed 200 are executed as described herein, the central support 214 may be formed in preparation for positioning the central support through the corresponding first and second support through holes 210, 212. Referring now to FIGS. 3A-3C, the central support 214 will now be described in more detail. More specifically, the central support 214 may initially be a substantially flat piece of paperboard that has a longitudinal fold line 302 defined or otherwise identified thereon. The longitudinal fold line 302 may extend along a substantially mid-section of the central support 214.

First and second perimeter clearance cutouts 304, 306 may be defined along the outer perimeter of the central support 214. The first and second perimeter clearance cutouts 304, 306 may be spaced from one another substantially the same distance as the first and second side supports 202, 204 in the assembled configuration of FIG. 2A. Further, the perimeter clearance cutouts 304, 306 have at least a couple of functional characteristics. First, the perimeter clearance cutouts 304, 306 may provide, in part, proper clearance for the central support 214 to rotate when folded along the longitudinal fold line 302 and positioned within the corresponding support through holes 210, 212. Second, a portion of the first and second side supports 202, 204 may be positioned within the corresponding perimeter clearance cutouts 304, 306 once the central support 214 is placed there through. In this configuration, the perimeter clearance cutouts 304, 306 may substantially restrict the first and second side supports 202, 204 from moving out of the folded position because portions of the first and second side supports 202, 204 are positioned within the corresponding perimeter clearance cutouts 304, 306.

Similarly, the central support 214 may also define a first and second central cutout 308, 310. The central cutouts 308, 310 may be spaced to correspond with the respective first and second perimeter clearance cutouts 304, 306. Further, both the central cutouts 308, 310 and the clearance cutouts 304, 306 may have a width that is about the same as the width of a cross section of the paperboard for the side supports 202, 204. In other words, portions of the side supports 202, 204 may be positioned within the central cutouts 308, 310 or the clearance cutouts 304, 306.

In one aspect of this disclosure, the central support 214 may be folded in half along the longitudinal fold line 302 as illustrated in FIG. 3B. While FIG. 3B shows the central support 214 only partially folded, in one aspect of this disclosure the central portion can be folded so that each side of the central support is positioned substantially adjacent the other. As will be described in more detail herein, the central support 214 may be positioned in the fully folded orientation during assembly of the infant bed 200.

In one aspect of this disclosure, the central portion 214 may be folded so that the overall width of the folded central portion 214 is D1. However, the clearance cutouts 304, 306 may be aligned with the corresponding central cutouts 308, 310 to define an internal cross-sectional distance D2 there along. As will be described in more detail in the following, the support through holes 210, 212 may be sized to correspond with the D1 and D2 sizes to allow the central portion 214 to be slid into the through holes 210, 212 while folded in half and then rotate about ninety degrees to become positioned in the installed position of FIG. 2A.

While the central portion 214 is described herein as a separate component from the infant bed 200, the central portion 214 may be removably coupled to the paperboard that defines the infant bed 200 prior to installation. More specifically, the central portion 214 may be integrally formed with the infant bed 200 but have perforations or the like that allow it to be easily separated therefrom. In this embodiment, when the user begins the assembly process, the central portion may be removed from the remaining portion of paperboard prior to installation.

Referring now to FIG. 3C one embodiment of a through hole 310 is illustrated. The through hole 310 could be implemented at any of the support through holes 210, 212 described herein. The through hole 310 may have a combination of an upper rectangular section 312 and a lower triangular section 314. The upper rectangular section 312 may have a width that is at least D1 and a thickness of T1. The thickness T1 and width may be sufficiently sized to allow the central member 214 to slide through the upper rectangular section 312 when the central member 214 is folded in half along the longitudinal fold line 302.

The lower triangular section 314 may be sized to define a minimum rotation distance 316 of D2. The minimum rotation distance 316 may be the shortest available clearance required for a linear member to rotate within the through hole 310 to become positioned adjacent differing corners 316, 318, 320 of the through hole. In other words, if a theoretical plate is placed in the upper rectangular section 312 and the plate has a width greater than D2, the theoretical plate will be unable to rotate from the being positioned proximate to the top two corners 316, 318 of the through hole 310. However, if the theoretical plate has a width of D2 or less, the theoretical plate will be able to rotate within the through hole 310 so that one end transitions to the corner 320.

As described above, the central member 214 has a folded width of D1 and an internal cross-sectional distance of D2. Accordingly, in one embodiment when the infant bed 200 is properly folded, the central member 214 is folded along the longitudinal fold line 302 and positioned in the upper rectangular section 312 of the support through holes 210, 212. Further, the central member 214 can slide within the support through holes 210, 212 until the corresponding cutouts 304, 306, 308, 310 are aligned with the corresponding side supports 202, 204 as described herein. Once properly aligned, the folded central member 214 may be rotated within the through holes 210, 212 until the longitudinal fold line 302 is positioned proximate to the corner 320. Next, the central member 214 can be unfolded into a V configurations with the corresponding cutouts 304, 306 being positioned in corresponding corners 316, 318.

In one aspect of this embodiment, after the central member 214 is within the through holes 210, 212 and unfolded as described above, the cutouts 304, 306, 308, 310 may partially overlap portions of the corresponding side supports 202, 204 to thereby substantially restrict the central member 214 from moving out of place. Further, the interaction between the cutouts 304, 306, 308, 310 and the corresponding side supports 202, 204 may maintain the side supports 202, 204 in the folded orientation as shown in FIG. 2A.

Another embodiment of this disclosure utilizes support through holes 210, 212 that are substantially triangular in cross section and do not have the upper rectangular section 312 described above. In this configuration, the central member 214 may be folded into a V-shaped cross section that corresponds with the triangular cross section of the through holes 210, 212. Then, the central member 214 may be slid through the corresponding through holes 210, 212 to become positioned adjacent the bottom seam 244 and thereby provide support thereto.

While a central support is described throughout this disclosure, embodiments that don't utilize a central support are also considered herein. In other embodiments, tape, adhesives, and other fasteners may be used to maintain proper form and structural performance of the assembly. Accordingly, while a central support is described herein, embodiments that don't utilize a central support are also contemplated.

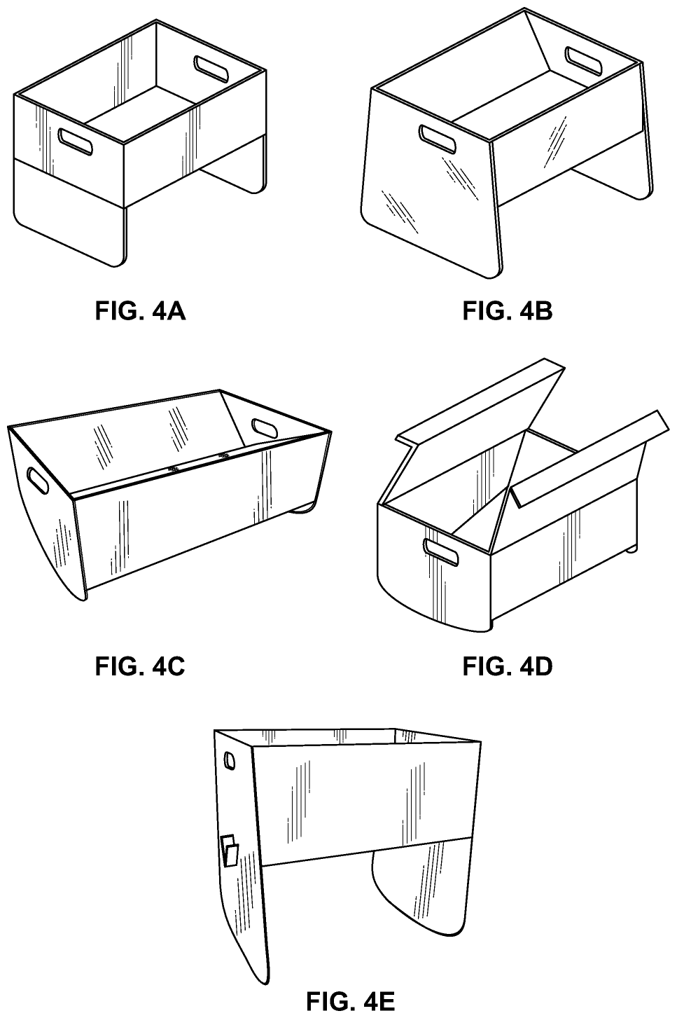

Referring now to FIGS. 4A-4E, several alternative embodiments of the present disclosure are illustrated. FIG. 4A may be substantially similar to FIG. 2A but not have a central support. FIG. 4B may be similar to FIG. 4A but have a flared base along the side members to provide additional stability. FIG. 4C and FIG. 4D may have short sides with a rounded bottom surface that allows the infant bed to be easily rocked. Similarly, FIG. 4E may utilize a central support, have extended side members that raise the infant bed off the ground, and a rounded edge that allows rocking. Accordingly, any combination of at least these embodiments are considered herein, along with variants thereof.

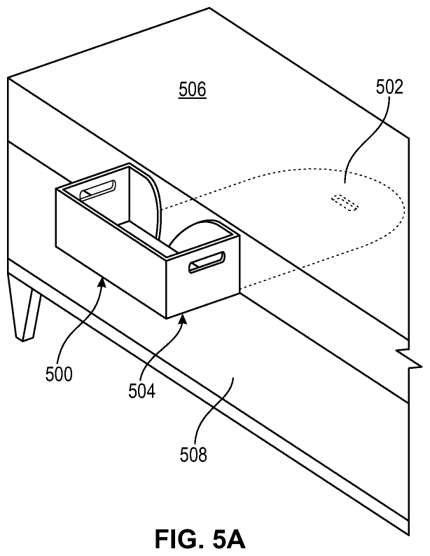

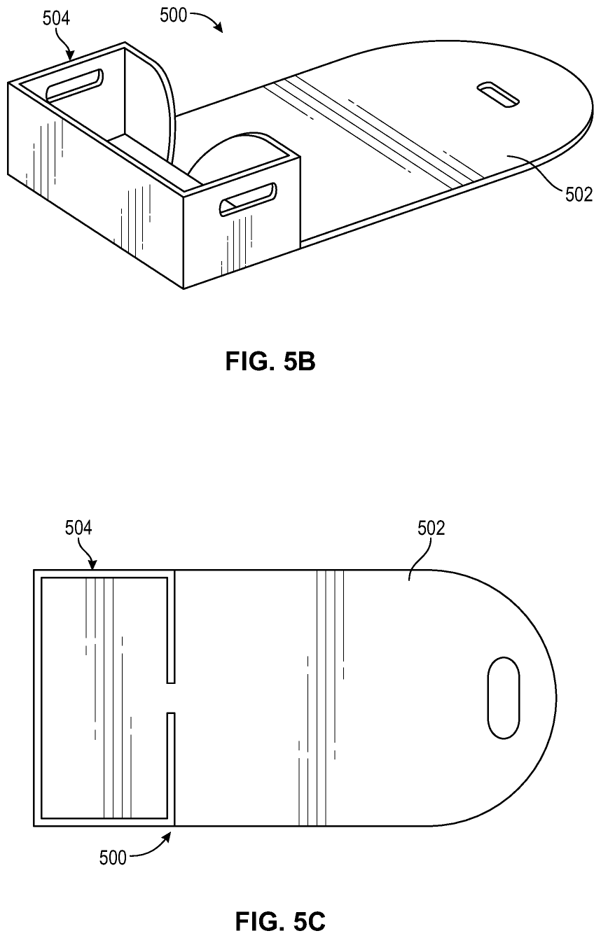

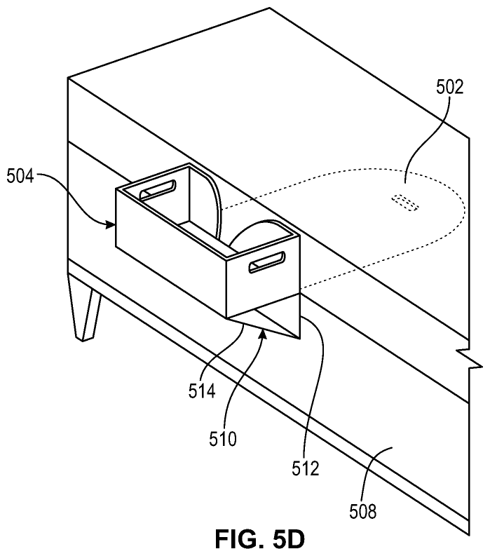

Referring now to FIG. 5A, another embodiment is shown. In FIG. 5A a safe infant sleeper 500 is illustrated. The infant sleeper 500 may have a flat, heat formed plastic plane 502 that has an extended surface and a formed trough 504 with four sides. The flat extended surface 502 fits between a mattress 506 and box spring 508 and is large enough to safely contain and secure one infant. An infant in the trough 504 is adjacent to and essentially sharing the same bed with parents without the danger of a roll over or suffocation. When the safe infant sleeper 500 is located between the mattress 506 and box spring 508 it is secured in place with only the trough 504 extended outward beyond and adjacent to the bed. This enables parents to safely locate an infant that is in the trough 504. This enables a mother in bed to see, reach over, and access the infant without having to rise and leave their bed. At the same time, the extended trough 504 keeps adults from rolling over onto the infant while sleeping. When needed, the infant sleeper 500 is simply slid between a mattress and box spring and it is ready to safely contain and secure an infant for sleep.

In one aspect of this disclosure the infant sleeper 500 may be a twenty-six inch wide by thirty-six inch long by three-sixteenths to one-quarter inch thick clear, plastic sheet that is heat formed resulting in a long, flat plane at one end and a fully enclosed trough 504 on the other. The rigid plastic plane secures the baby and sleeper in place and will not move without a deliberate action on the part of an adult. In this configuration, the cantilevered baby is close to the adult.

Referring now to FIG. 5D, another embodiment of the infant sleeper 500 is illustrated. In this embodiment, an additional support assembly 510 may be coupled to the infant sleeper 500 or otherwise formed therewith. The addition support assembly may have a vertical portion 512 that extends from the plastic plane 502 towards the ground when positioned in a bed. Further, the vertical portion 512 may be positioned to be located adjacent to the box spring 508 when coupled to the bed. Further, a supplemental support arm may extend from a distal portion of the vertical portion diagonally towards an outside edge of the trough 504 or plastic plane 502. The supplemental support arm 514 may provide additional structural support to the trough 504 by restricting substantial deflection of the trough 504 relative to the bed.

In one aspect of this embodiment, a simple washable pad fits onto the floor of the safety sleeper making for a soft and comforting base on which the infant sleeps safely on their back. The plastic unit can be easily removed from in between the mattress and box spring and cleaned, moved to another bed or stored. The one piece sleeper is heat formed, strong, and will easily support an infant up to six months of age.

Referring now to FIG. 6A, yet another embodiment of the present disclosure is illustrated. More specifically, FIG. 6 illustrates a netting assembly 600 coupled to a bed assembly 602. The netting assembly 600 may be comprised of a first and second support panel 606, 608. The support panels 606, 608 may be die cut, corrugate “D” shaped panels that can be attached to the sides of any of the embodiments shown and described herein. Once in place, netting 610 can be located over the entire bed assembly 602 and provide protection from mosquitoes and other insects or annoyances while allowing air to flow freely around the infant. Hand holes 612 would match those on the bed assembly 602 enabling an adult to easily lift and move an infant located in the bed assembly 602.

In another embodiment of the netting assembly 600, each support panel 606, 608 may be formed from a single piece of paperboard folded at a top end to form a first and second side of each support panel 606, 608. The first and second sides of each support panel may be positioned on the corresponding first and second interior and exterior sides 120, 126, 122, 128. For example, the first side of the first support panel 606 may be coupled to the first exterior side 122 and the second side of the first support panel 606 may be coupled to the first interior side 120. The second support panel 608 may be similarly coupled to the corresponding second interior and exterior sides 126, 128. The support panels 606, 608 may be coupled to the corresponding sides utilizing any of the coupling mechanisms described herein, and this disclosure considers any coupling method known in the art.

Referring now to FIG. 6B, yet another embodiment of the present disclosure is illustrated. In this embodiment, the support panels 606, 608 may be integrally formed from the same piece of paperboard as the remaining portion of the infant sleeper. In this embodiment, the support panels 606, 608 may be positioned along end sections of the infant bed rather than the side portions described above. Further, the support panels 606, 608 may be folded substantially ninety degrees to provide adequate supporting for netting to be positioned thereover without substantially contacted an infant positioned within the infant sleeper.

Many different materials are considered to provide adequate structure to the various embodiments described herein, and this disclosure considers materials not specifically discussed. However, in addition to paperboard, at least cardboard, plastic, foam, metal, wood, and the like materials are also considered herein. Further, while specific folds are identified throughout, additional folds are also considered herein. More specifically, this disclosure considers any folding pattern that may facilitate easy shipping dimensions or assembly.

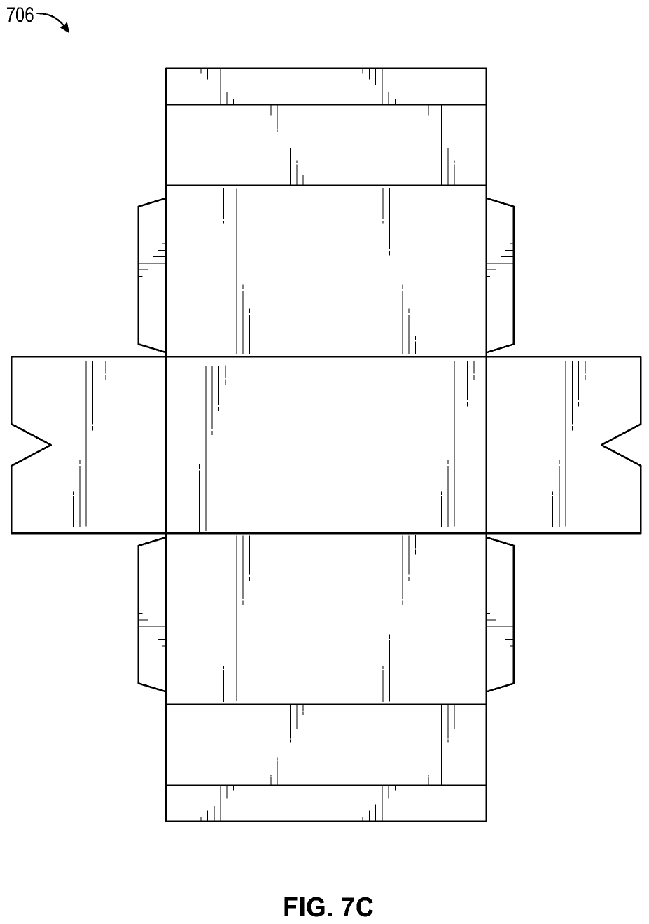

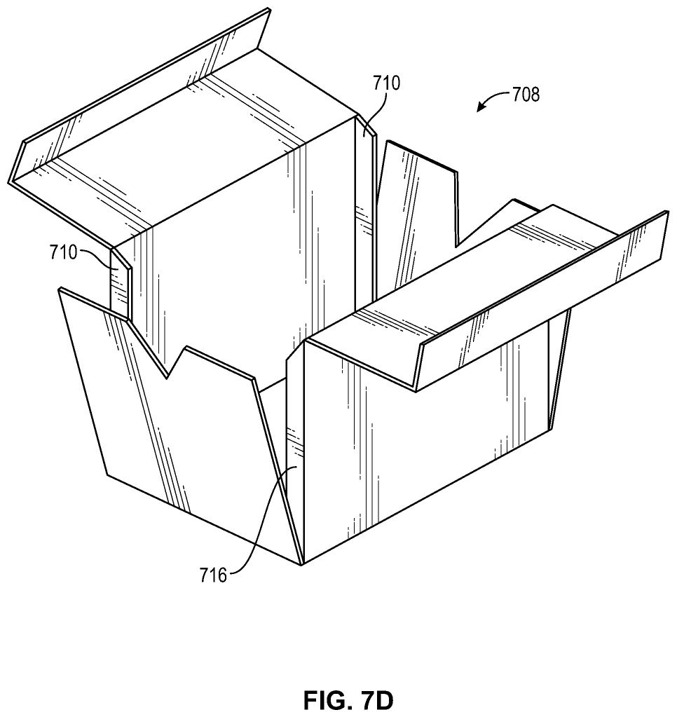

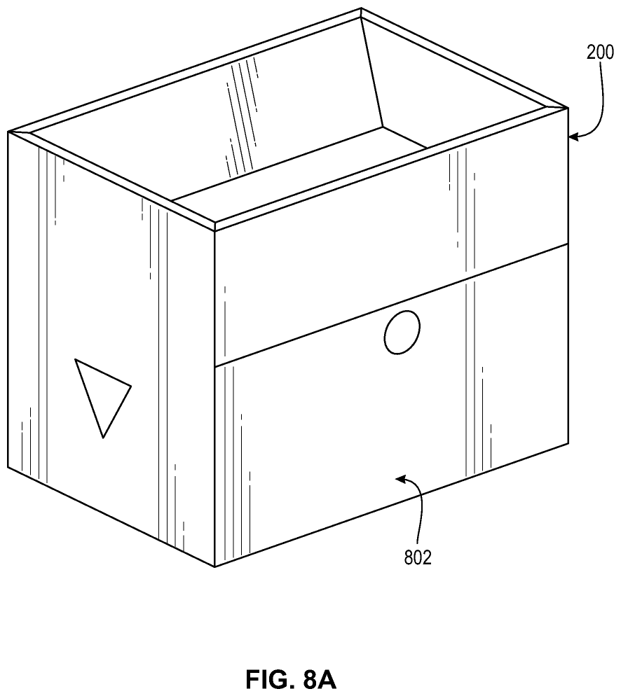

Referring now to FIG. 7A, a cradle base 700 is shown coupled to the infant bed 200. The cradle base 700 may be formed from substantially the same material as the infant bed 200 and utilize similar assembly techniques as those described herein for the infant bed 200 and the like. The cradle base 700 can be sized to safely raise the infant bed 200 to a distance that may be more suitable for the parent. In one embodiment, the cradle base 700 is sized to raise the infant bed 200 to about a bed height of the parent. This may allow the infant to become positioned next to the parent's bed without positioning the infant in the bed. Accordingly, the infant can be close to the parent at night without the risks associated with having an infant in the same bed as the parent.

The cradle base 700 may raise the infant bed 200 any height that is safe for the infant. In one embodiment, the cradle base 700 raises the infant bed 200 higher than the parent's bed. In this embodiment the cradle base 700 may raise the infant bed 200 to a height that is more convenient for a standing adult to tend to the infant. Alternatively, the cradle base 700 may be a height that positions the infant bed 200 at a location lower than the adult's bed. Accordingly, this disclosure considers many different cradle base 700 heights.

Referring now to FIG. 7B, the cradle base 700 is shown without the infant bed 200 positioned thereon. The cradle base 700 may have one or more contact surface 702 and a central support channel 704. The contact surface 702 may be positioned to contact the bottom portion of the infant bed 200 and the central support channel 704 may be sized to correspond with the central support 214. Accordingly, the infant bed 200 can be set on top of the cradle base 702 with the central support 214 positioned at least partially within the central support channel 704. In this configuration, the positioning of the central support 214 within the central support channel 704 may substantially restrict the infant bed 200 from sliding off the cradle base 700. Further, the first and second side supports 202, 204 may at least partially extend along corresponding first and second sides of the cradle base 700, thereby further restricting movement of the infant bed 200 relative to the cradle base 700.

In one non-exclusive example, adhesive, slots and tabs, Velcro, glue, or any other known coupling mechanism may be implemented on the contact surface 702. Alternatively, in other embodiments the infant bed 200 maintains proper positioning on the cradle base 700 without using any additional coupling mechanisms.

The cradle base 700 may be formed from a one piece of two ply corrugated paperboard that is die cut, scored, folded, and fastened as shown in FIGS. 7C and 7D. More specifically, FIG. 7C shows the cradle base 700 in a substantially flat configuration 706. The flat configuration 706 may allow the cradle base 700 to be easily stored and shipped or otherwise transported. Further, the cradle base 700 may be folded from the flat configuration 706 to achieve dimensions that may be more ideal for shipping. Accordingly, this disclosure considers forming the cradle base 700 in any folded or flat configuration that may be efficient for storing or transporting the cradle base 700.

FIG. 7D shows the cradle base 700 in the partially folded configuration 708. As is apparent from FIG. 7D, the cradle base 700 may utilize tabs 710 to couple the sides of the cradle base 700 to one another to thereby form the cradle base 700 in the assembled configuration of FIG. 7B.

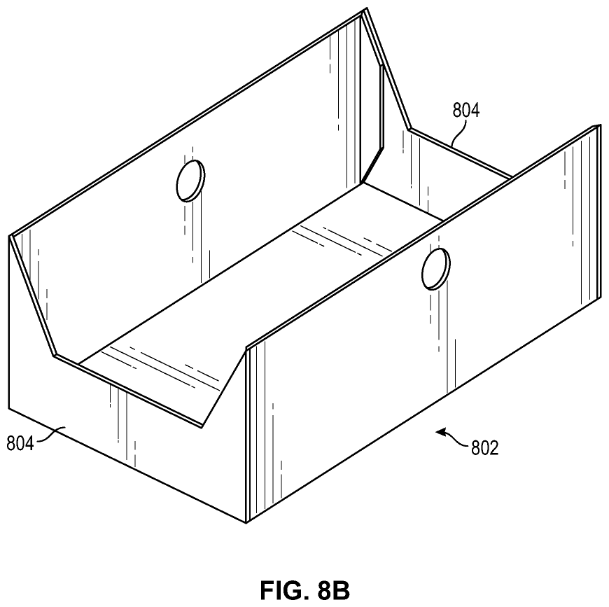

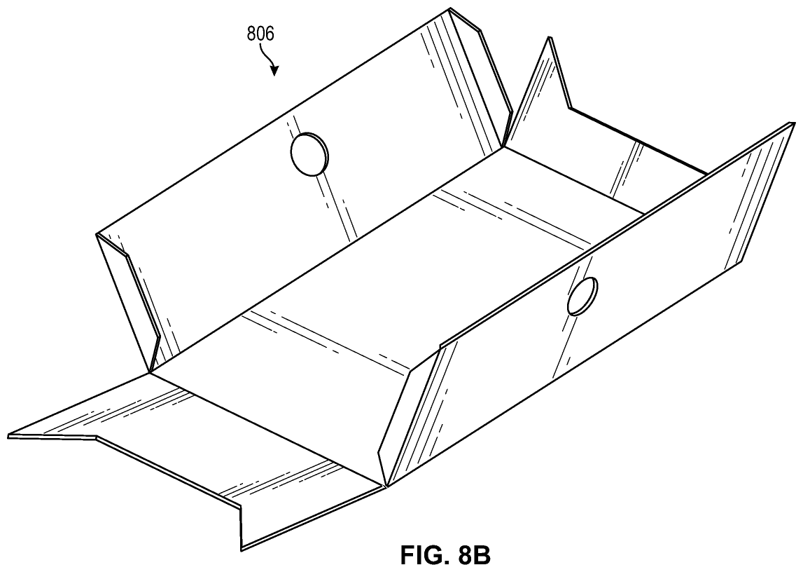

FIGS. 8A-8C show another embodiment of the infant bed 200 that has a drawer 802 positioned thereunder. The drawer 802 may be sized to fit in the space between the first and second side supports 202, 204 of the infant bed 200 and sit on the underlying surface. Further, the drawer 802 may have partially U-shaped end sections 804 that allow the central support 214 to be at least partially positioned within a cavity of the end sections 804 when the drawer 802 is placed under the infant bed 200 as illustrated in FIG. 8A. The end section 804 may also be sized to contact the central support 214 when the drawer 802 is in an open position. In this configuration, the central support 214 contacts the drawer 802 to establish a fully opened position. However, the drawer 802 may be removed from the infant bed 200 by further rotating the drawer 802 so the end sections 804 clear the central support 214.

The drawer 802 may be formed of the same material and utilizing the same principles of assembly as the infant bed 200. More specifically, the partially folded drawer 806 illustrates how the drawer 802 can be formed from a single piece of paperboard or the like utilizing the illustrated folds and template.

In one aspect of this disclosure, any of the embodiments taught herein may be utilized for infants from about zero to sixth months old, or until the infant is able to roll over. Similarly, warning instructions may be printed on the paperboard or otherwise coupled thereto identifying potential hazards of improper use. Further, assembly instructions may also be printed directly on the paperboard or otherwise be coupled thereto.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

The terminology used herein is for the purpose of describing particular illustrative embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations).

What is claimed is:

1. A barrier for an infant, comprising:
a central portion sized to receive an infant thereon; and
a first and second side portion extending partially away from the central portion;
wherein the central portion and first and second side portions are formed from folds in an integral material.

2. The barrier of claim 1, further wherein the first and second side portions are the only portions that extend partially away from the central portions.

3. The barrier of claim 1, further wherein the first and second side portions have a triangular cross section.

4. The barrier of claim 1, further wherein the integral material is paperboard.

5. The barrier of claim 1, further wherein the folds of the integral material result in a first edge and a second edge of the integral material being aligned substantially adjacent one another at a seam.

6. The barrier of claim 5, further wherein the seam is located along a middle section of the central portion.

7. The barrier of claim 1, further wherein the barrier for an infant is formed from one piece of two ply corrugated paperboard that is die cut, scored, and folded.

8. The barrier of claim 1, further comprising a first D-shaped section coupled to the first side portion and a second D-shaped section coupled to the second side portion, wherein the first and second D-shaped sections are sized to allow netting to be positioned over the central portion without contacting an infant positioned therein.

9. The barrier of claim 1, further comprising:
a first side support extending between the first and second side portions at a first end; and
a second side support extending between the first and second side portions at a second end;
wherein, the first and second side supports are sized to raise the central portion off an underlying surface.

10. The barrier of claim 9, further comprising a first support through hole defined by the first side support and a second support through hole defined by the second side support, wherein the first and second side supports are sized to receive a central support therethrough.

11. The barrier of claim 10, further wherein the first and second support through holes have a triangular shaped periphery and the central support is sized to be positioned within the first and second support in a V-shaped orientation.

12. A bed assembly configured to be placed on an underlying surface, comprising:
a bed portion;
a first side support section coupled to the bed portion; and
a second side support section coupled to the bed portion at an opposite end relative to the first side support section;
wherein, the first side support section, the second side support section, and the bed portion are formed from folds in a material.

13. The bed assembly of claim 12, further wherein the bed portion is elevated relative to the udnerlying surface by the first and second side support sections.

14. The bed assembly of claim 12, further wherein the first side support section defines a first through hole therein and the second side support section defines a second through hole therein; wherein the first and second through holes are sized to receive a central support therethrough.

15. The bed assembly of claim 14, further wherein the first and second through holes are positioned to align the central support with a bottom seam of the bed portion.

16. The bed assembly of claim 14, further wherein the central portion defines cutouts therein, wherein when the central support is positioned within the corresponding first and second through holes a portion of the first and second side support sections is positioned in corresponding cutouts of the central support.

17. The bed assembly of claim 12, further comprising a first D-shaped section coupled to the first side portion and a second D-shaped section coupled to the second side portion, wherein the first and second D-shaped sections are sized to allow netting to be positioned over the central portion without contacting an infant positioned therein.

18. A method for instructing a user to build a barrier for an infant, the method comprising:
providing a substantially flat material with a plurality of fold indications positioned thereon;
instructing the user to execute folds along the plurality of fold indications to manipulate the material to define a central portion sized to receive an infant thereon and a first and second side portion extending partially away from the central portion;
instructing the user to apply a mechanical or adhesive fastener to the material to maintain the instructed configuration of the central portion and the first and second side portions.

19. The method of claim 18, further comprising instructing a user to fold down a first side support and a second side support to elevate the central portion off an underlying surface.

20. The method of claim 19, further comprising instructing the user to position a central support between the first side support and the second side support.
